(19) United States
(12) Patent Application Publication
(10) Pub. No.: US 2019/0282904 A1
(43) Pub. Date: Sep. 19, 2019

(54) COMPUTER-READABLE RECORDING MEDIUM, COMPUTER APPARATUS, AND CONTROL METHOD FOR PROGRAM

(71) Applicant: SQUARE ENIX CO., LTD., Tokyo (JP)

(72) Inventor: Daniel HEDJAZI, Osaka (JP)

(73) Assignee: SQUARE ENIX CO., LTD., Tokyo (JP)

(21) Appl. No.: 16/299,312

(22) Filed: Mar. 12, 2019

(30) Foreign Application Priority Data
Mar. 14, 2018 (JP) 2018-046121

(51) Int. Cl. A63F 13/55; A63F 13/23; A63F 13/833; A63F 13/25; A63F 13/67

(52) U.S. Cl. CPC A63F 13/55; A63F 13/23; A63F 13/833; A63F 2300/6027; A63F 13/67; A63F 2300/8029; A63F 13/25

(57) ABSTRACT

To provide a more interesting game is an object.

In a game that is progressed by controlling a first character operated by a player and a second character fighting with the first character, a related character is generated based on data of the first character; and the generated related character is controlled as a second character in a case where the first character satisfies a predetermined condition.

### CROSS REFERENCE TO RELATED APPLICATION

The present disclosure relates to subject matter contained in Japanese Patent Application No. 2018-46121, filed on Mar. 14, 2018, the disclosure of which is expressly incorporated herein by reference in its entirety.

### TECHNICAL FIELD

The present invention relates to a computer-readable recording medium, a computer apparatus, and a control method for a program.

### BACKGROUND ART

In the related art, there is a game that is progressed by causing a player character operated by a player and an enemy character controlled by a computer to fight with each other. For example, an action game is progressed by operating a player character to fight with and win an enemy character. Since fights between the player character and the enemy character controlled by the computer are controlled in a predetermined manner, the fights may be developed in a similar way.

### SUMMARY OF INVENTION

### Technical Problem

An object of at least one embodiment of the present invention is to provide a more interesting game.

### Solution to Problem

According to a non-limiting aspect, a non-transitory computer-readable recording medium including a program which is executed in a computer apparatus providing a game that is progressed by controlling a first character operated by a player and a second character fighting with the first character, the program causing the computer apparatus to function as: a related character generator that generates a related character related to the first character based on data of the first character; and a second character controller that controls the related character generated by the related character generator as the second character in a case where the first character satisfies a predetermined condition.

According to a non-limiting aspect, a computer apparatus providing a game that is progressed by controlling a first character operated by a player and a second character fighting with the first character, the apparatus comprising: a related character generator that generates a related character based on data of the first character; and a second character controller that controls the related character generated by the related character generator as the second character in a case where the first character satisfies a predetermined condition.

According to a non-limiting aspect, a control method for a program which is executed in a computer apparatus providing a game that is progressed by controlling a first character operated by a player and a second character fighting with the first character, the method comprising: generating a related character based on data of the first character; and controlling the generated related character as the second character in a case where the first character satisfies a predetermined condition.

### Advantageous Effects of Invention

One or more of the above problems can be solved with each embodiment of the present invention.

### BRIEF DESCRIPTION OF THE DRAWINGS

FIG. 1 is a block diagram illustrating a configuration of a computer apparatus which corresponds to at least one of the embodiments of the present invention.

FIG. 2 is a flowchart of a program execution process which corresponds to at least one of the embodiments of the present invention.

FIG. 3 is a block diagram illustrating a configuration of a computer apparatus which corresponds to at least one of the embodiments of the present invention.

FIG. 4 is a flowchart of a program execution process, which corresponds to at least one of the embodiments of the present invention.

FIG. 5 is a block diagram illustrating a configuration of a computer apparatus which corresponds to at least one of the embodiments of the present invention.

FIG. 6 is a block diagram illustrating a configuration of a computer apparatus which corresponds to at least one of the embodiments of the present invention.

FIG. 7 is a block diagram illustrating a configuration of a computer apparatus which corresponds to at least one of the embodiments of the present invention.

FIG. 8 is a flowchart of a program execution process, which corresponds to at least one of the embodiments of the present invention.

FIG. 9 is an example of an object specification master table, which corresponds to at least one of the embodiments of the present invention.

FIGS. 10A and 10B are examples of an object specification master table, which correspond to at least one of the embodiments of the present invention.

FIG. 11 is an example of an attribute change master table, which corresponds to at least one of the embodiments of the present invention.

FIG. 12 is a view illustrating the display mode of the related character, which corresponds to at least one of the embodiments of the present invention.

FIG. 13 is a block diagram illustrating a configuration of a system, which corresponds to at least one of the embodiments of the present invention.

FIG. 14 is a block diagram illustrating a configuration of the server apparatus, which corresponds to at least one of the present embodiments of the invention.

FIG. 15 is a block diagram illustrating a configuration of the system, which corresponds to at least one of the embodiments of the present invention.

FIG. 16 is a flowchart of an execution process, which corresponds to at least one of the embodiments of the present invention.

### DESCRIPTION OF EMBODIMENTS

Hereinafter, embodiments of the invention will be described with reference to the accompanying drawings. Hereinafter, description relating to effects shows an aspect of the effects of the embodiments of the invention, and does not limit the effects. Further, the order of respective processes that form a flowchart described below may be changed in a range without contradicting or creating discord with the processing contents thereof.

### First Embodiment

First, the outline of a first embodiment of the invention will be described. In the following description, as the first embodiment, a program executed in a computer apparatus that provides a game will be described with an example. As the game, for example, a game that is progressed by controlling a first character operated by a player and a second character fighting with the first character will be described.

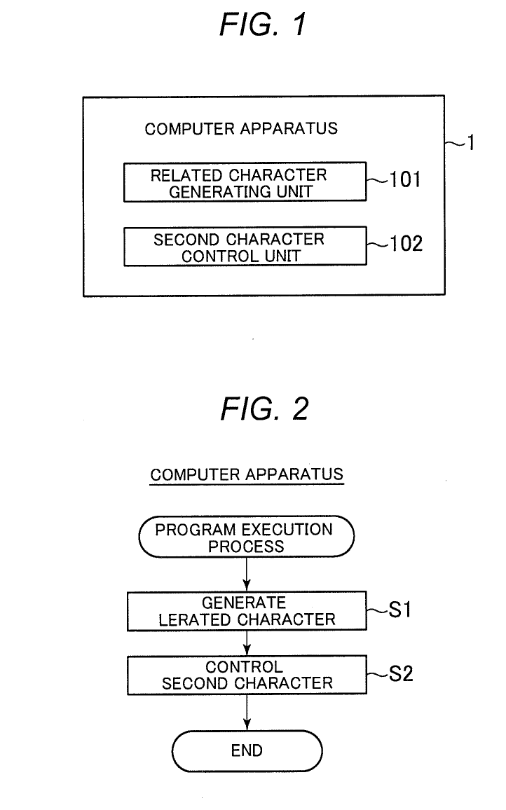

FIG. 1 is a block diagram illustrating a configuration of a computer apparatus which corresponds to at least one of the embodiments of the present invention. A computer apparatus 1 includes at least a related character generating unit 101 and a second character control unit 102.

The related character generating unit 101 has a function of generating a related character related to a first character based on data of the first character. The second character control unit 102 has a function of controlling a related character generated by a related character generator as a second character in a case where the first character satisfies a predetermined condition.

Next, a program execution process in the first embodiment of the invention will be described. FIG. 2 is a flowchart of a program execution process, which corresponds to at least one of the embodiments of the present invention.

The computer apparatus 1 generates the related character related to the first character based on the data of the first character (Step S1). Next, the computer apparatus 1 controls the related character generated by the related character generator as the second character in a case where the first character satisfies the predetermined condition (Step S2) and terminates the process.

According to an aspect of the first embodiment, it is possible to provide a more interesting game.

In the first embodiment, a “player” means, for example, a user who plays the game by operating a terminal. The “first character” means, for example, an in-game object that exists instead of the player and also means an object such as a vehicle that can be operated by the player and that a player character can board or an object that acts with the player character. The “second character” means, for example, a character that fights with the first character. The “game” means, for example, a computer game executed by activating a program in a computer apparatus or a player terminal and the genre of the game contents does not matter.

The “computer apparatus” means, for example, a cellular phone, a smart phone, a tablet computer, a personal computer, a portable game machine, a stationary game machine, a wearable terminal, or the like and means a device that can execute a program. The “related character” means, for example, a character generated based on the data of the first character.

### Second Embodiment

Next, the outline of a second embodiment of the invention will be described. In the following description, as the second embodiment, a program executed in a computer apparatus that provides a game will be described with an example. As the game, for example, a game that is progressed by controlling a first character operated by a player and a second character fighting with the first character will be described.

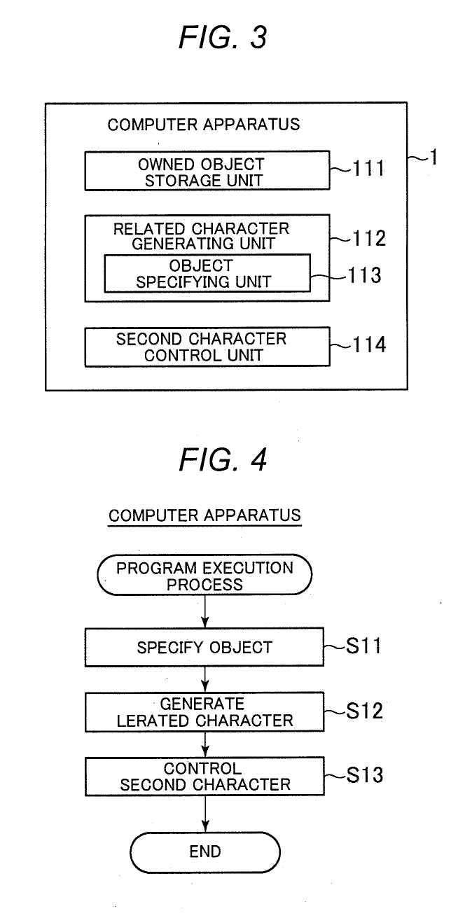

FIG. 3 is a block diagram illustrating a configuration of a computer apparatus which corresponds to at least one of the embodiments of the present invention. The computer apparatus 1 includes at least an owned object storage unit 111, a related character generating unit 112, an object specifying unit 113, and a second character control unit 114.

In the second embodiment, the owned object storage unit 111 has a function of storing a first character and an object owned by the first character such that the first character and the object are related to each other. The related character generating unit 112 has a function of generating a related character related to the first character based on data of the first character. The object specifying unit 113 has a function of specifying at least one object from objects owned by the first character. The second character control unit 114 has a function of controlling a related character generated by a related character generator as a second character in a case where the first character satisfies a predetermined condition.

The related character generating unit 112 generates a related character related to the object specified by the object specifying unit 113.

Next, a program execution process in the second embodiment of the invention will be described. FIG. 4 is a flowchart of a program execution process, which corresponds to at least one of the embodiments of the present invention.

The computer apparatus 1 specifies at least one object from the objects owned by the first character (Step S11). The computer apparatus 1 generates the related character related to the first character based on the data of the first character (Step S12). Here, the generated related character is generated in relation to the object specified in Step S11.

Next, the computer apparatus 1 controls the related character generated by the related character generator as the second character in a case where the first character satisfies the predetermined condition (Step S13) and terminates the process.

According to an aspect of the second embodiment, it is possible to provide a more interesting game.

According to an aspect of the second embodiment, the related character related to the object specified from the objects owned by the first character is generated. Therefore, a related character corresponding to the state of the first character is generated and thus it is possible to provide a more interesting game.

With regard to the expressions “player”, “first character”, “second character”, “game”, “computer apparatus”, and “related character” in the second embodiment, the contents described in the first embodiment can be adopted within a necessary range.

In the second embodiment, the “object” means, for example, a character, a card, an item, a body part of a character, or the like appearing in the game. The expression “to relate a character and an object” means, for example, to update character information such that it becomes possible to refer to information of the object from the character information managed by the computer apparatus and to make the object available to the character in the game. That is, the expression “to relate a character and an object with each other” also includes to give or lend the object to a player who can operate the character. The expression “to be owned” means, for example, to be carried as an object belonging to the character and also includes to be carried to be available in the game or to be equipped by a character.

### Third Embodiment

Next, the outline of a third embodiment of the invention will be described. In the following description, as the third embodiment, a program executed in a computer apparatus that provides a game will be described with an example. As the game, for example, a game that is progressed by controlling a first character operated by a player and a second character fighting with the first character will be described.

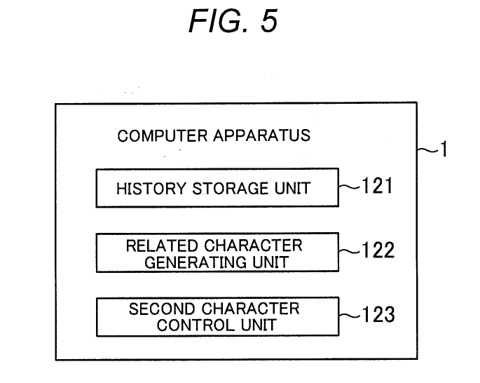

FIG. 5 is a block diagram illustrating a configuration of a computer apparatus which corresponds to at least one of the embodiments of the present invention. The computer apparatus 1 includes at least a history storage unit 121, a related character generating unit 122, and a second character control unit 123. With regard to the flow of a program execution process in the third embodiment, the flow illustrated in the flowchart in FIG. 2 can be adopted within a necessary range.

In the third embodiment, the history storage unit 121 has a function of storing history information related to an operation of a player with respect to a first character. The related character generating unit 122 has a function of generating a related character related to the first character based on data of the first character. The second character control unit 123 has a function of controlling a related character generated by a related character generator as a second character in a case where the first character satisfies a predetermined condition.

The second character control unit 123 controls the second character that corresponds to the related character generated based on the data of the first character, the second character being controlled based on the history information stored in the history storage unit 121.

According to an aspect of the third embodiment, it is possible to provide a more interesting game.

According to an aspect of the third embodiment, the second character that corresponds to the related character generated based on the data of the first character is controlled based on the history information that is related to an operation of the player with respect to the first character. Therefore, the second character can be controlled by using a pattern related to an operation that is consciously or unconsciously performed by a player (so-called player's habits in playing game) and thus it is possible to provide a more interesting game to the player. Furthermore, it is possible to provide information with which the player can be aware of his or her own pattern and play the game without being stuck in a pattern and thus it is possible to motivate the player to further focus on the game more.

With regard to the expressions “player”, “first character”, “second character”, “game”, “computer apparatus”, and “related character” in the third embodiment, the contents described in the first embodiment can be adopted within a necessary range.

### Fourth Embodiment

Next, the outline of a fourth embodiment of the invention will be described. In the following description, as the fourth embodiment, a program executed in a computer apparatus that provides a game will be described with an example. As the game, for example, a game that is progressed by controlling a first character operated by a player and a second character fighting with the first character will be described.

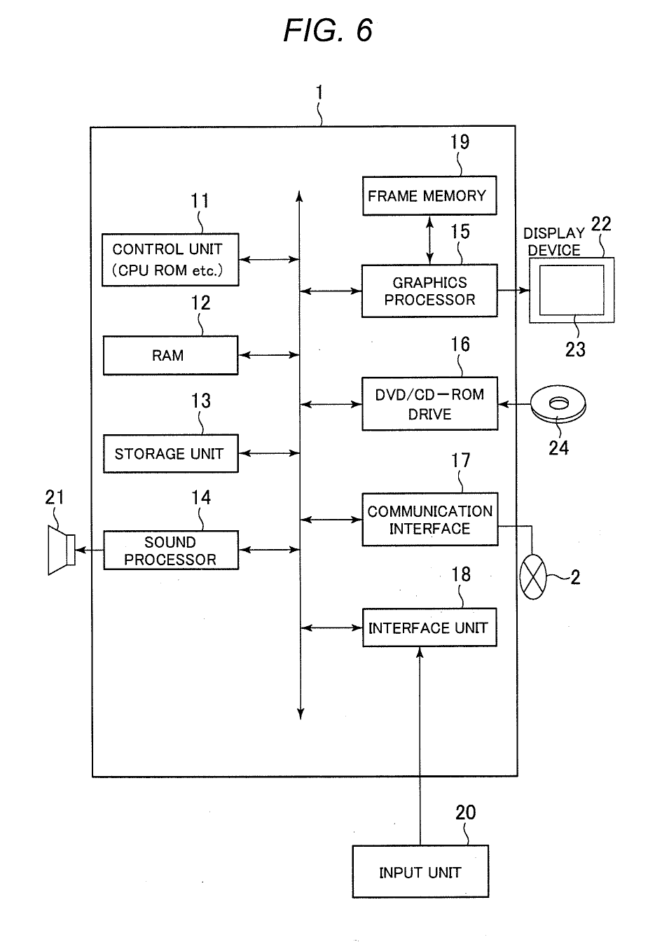

FIG. 6 is a block diagram illustrating a configuration of a computer apparatus which corresponds to at least one of the embodiments of the present invention. The computer apparatus 1 includes at least a control unit 11, a random-access memory (RAM) 12, a storage unit 13, a sound processor 14, a graphics processor 15, an external recording medium reading unit 16, a communication interface 17, and an interface unit 18, which are connected to each other via an internal bus.

A central processing unit (CPU) or a read only memory (ROM) constitutes the control unit 11. The control unit 11 executes a program stored in the storage unit 13 or an external recording medium 24 and controls the computer apparatus 1. In addition, the control unit 11 includes an internal timer that measures time. The RAM 12 is the work area of the control unit 11. The storage unit 13 is a storage region for storing a program or data.

The external recording medium 24 in which a program is stored can be mounted into the external recording medium reading unit 16. The external recording medium 24 stores, for example, a program and data. Examples of the external recording medium 24 include a ROM cartridge, a BD-ROM, a DVD-ROM, or a CD-ROM and the like. The external recording medium reading unit 16 reads a program and data from the external recording medium 24 and the program and the data are loaded into the RAM 12.

The control unit 11 performs a process by reading the program and the data from the RAM 12. The control unit 11 processes the program and the data loaded into the RAM 12 so as to output a sound output instruction to the sound processor 14 and a drawing command to the graphics processor 15.

The sound processor 14 is connected to a sound output device 21, which is a speaker. When the control unit 11 outputs the sound output instruction to the sound processor 14, the sound processor 14 outputs a sound signal to the sound output device 21.

The graphics processor 15 is connected to a display device 22. The display device 22 includes a display screen 23. When the control unit 11 outputs the drawing command to the graphics processor 15, the graphics processor 15 deploys an image in a frame memory (frame buffer) 19 and outputs a video signal for displaying an image on the display screen 23. The graphics processor 15 performs the drawing of one image in units of frames. A time for one frame of an image is, for example, 1/30 seconds. The graphics processor 15 takes charge of a portion of a calculation process related to a drawing process, which has been performed by only the control unit 11, and the graphics processor 15 has a role for load distribution over the entire system.

An input unit 20 (for example, mouse, keyboard, controller, or the like) may be connected to the interface unit 18. Input information that is input via the input unit 20 by a user is stored in the RAM 12 and the control unit 11 executes various calculation processes based on the input information. Alternatively, a recording medium reading device may be connected to the interface unit 18 and a program and data may be read from a memory or the like. In addition, the display device 22 provided with a touch panel may be used as the input unit 20.

The communication interface 17 can be connected to a communication network 2 in a wireless or wired manner and can transmit or receive information to or from another computer apparatus via the communication network 2.

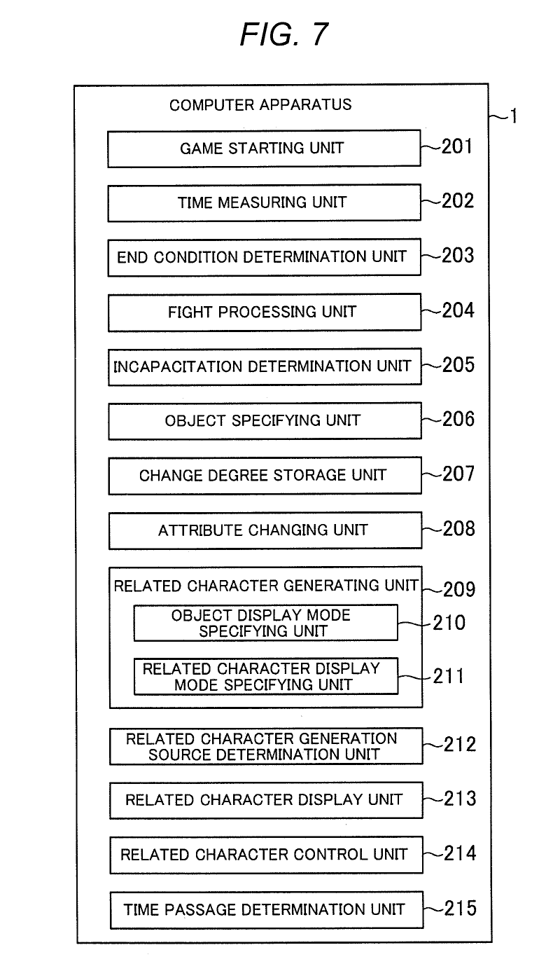

FIG. 7 is a block diagram illustrating a configuration of a computer apparatus which corresponds to at least one of the embodiments of the present invention. The computer apparatus 1 includes at least a game starting unit 201, a time measuring unit 202, an end condition determination unit 203, a fight processing unit 204, a incapacitation determination unit 205, an object specifying unit 206, a change degree storage unit 207, an attribute changing unit 208, a related character generating unit 209, an object display mode specifying unit 210, a related character display mode specifying unit 211, a related character generation source determination unit 212, a related character display unit 213, a related character control unit 214, and a time passage determination unit 215.

The game starting unit 201 has a function of starting the game. The game may be, for example, a game that has a story such as a role playing game (RPG) partitioned with dungeons or the like or a stage-based game such as an action game that is progressed by clearing a plurality of stages one by one. The time measuring unit 202 has a function of measuring a time elapsed after the start of the game.

The end condition determination unit 203 has a function of determining whether the game has ended or not. The fight processing unit 204 has a function of processing a fight between the player character and an opponent character. The incapacitation determination unit 205 has a function of determining whether the player character has been incapacitated. The object specifying unit 206 has a function of specifying at least one object from objects owned by a character.

The change degree storage unit 207 has a function of storing the state of progress of the game and information indicating a degree to which the attribute of an object is changed such that the progress and the degree are related to each other. The attribute changing unit 208 has a function of changing the attribute of the object to a degree corresponding to the state of progress. The related character generating unit 209 has a function of generating a related character related to a player character based on data of the player character.

The object display mode specifying unit 210 has a function of specifying a display mode of a plurality of objects, with which body parts of the related character are respectively equipped, corresponding to a display mode of a plurality of objects, with which body parts of the player character are respectively equipped. The related character display mode specifying unit 211 has a function of specifying a display mode of the related character based on a display mode of the specified object.

The related character generation source determination unit 212 has a function of determining whether a generation source object that can generate the related character is present in the game or a stage. The related character display unit 213 has a function of displaying the related character corresponding to the display mode of the related character that is specified by the related character display mode specifying unit 211. The related character control unit 214 has a function of controlling the related character generated by the related character generating unit 209 as the opponent character. The time passage determination unit 215 has a function of determining whether a predetermined time has elapsed after a predetermined time point.

(Outline of Game) A game in the fourth embodiment of the invention will be described. As an example of the game, a fighting game in which a player character (first character) operated by a player is caused to act on a game field and to fight with an opponent character (second character) will be described. As the fighting game, a turn-based battle game which is progressed by a player and an opponent player alternately issuing operation instructions or an action which is progressed in real time may be adopted. In addition, a so-called open world game in which a character can freely move in a wide in-game space or a game which is progressed by clearing a plurality of stages one by one may also be adopted. In the following description, as an example, an action game which is progressed in real time and is progressed by clearing stages one by one.

A game end condition for the game to end may be a condition that the player character is defeated a predetermined number of times, a condition that the player character defeats the all of opponent characters, a condition that the player character knocks down an object having a predetermined attribute in an event, or a condition that a predetermined time is elapsed after the start of the game. In a case where the game ends when a predetermined time elapses, determination on whether the player has won or lost may be performed based on information related to an object that is present on a game field at the time of the end or based on history information of the player character. Note that, the genre of the game is not limited to the above-described games and the fourth embodiment can be applied to any game regardless of a genre (for example, fourth embodiment can be applied to simulation game, action game, or the like). In the following description, a game in which the second character is a character controlled by a computer and one player character fights with a plurality of opponent characters will be used as an example. The game end condition is as follows, for example. The game is cleared when the player character wins an opponent character having a predetermined attribute or all of opponent characters in a predetermined game field are defeated and the game becomes over when the player character enters an incapacitated state a predetermined number of times.

(Character) For each character, parameters used in the game (for example, attacking power, defending power, maximum hit point, or the like) or skills or the like having predetermined effects are set. The player selects a certain character from selectable characters and performs a virtual battle with an opponent character or another player. The outcome of the virtual battle is determined based on parameters set for the characters or the attributes of the skills.

A character can change the parameters or the attribute thereof by being equipped with an in-game object (hereinafter, may be referred to as equipment). The in-game object can be applied in various forms such as a weapon or protective equipment like a sword or an armor, a part for a robot like an arm, a body, or an armor, or a character belonging to the player character like a guardian or a pet and the form of the in-game object is not limited. In addition, each of the head, the body, the shoulders, the right and left upper arm portions, the right and left front arm portions, the right and left hands, the right and left legs, the back, and the waist of a character may be able to be equipped with the in-game object.

Furthermore, for each character, for example, a rarity that indicates the degree of rarity in the game may be set and a character that the player can select may become able to be acquired by lottery in exchange for a predetermined cost.

(Program Execution Process)

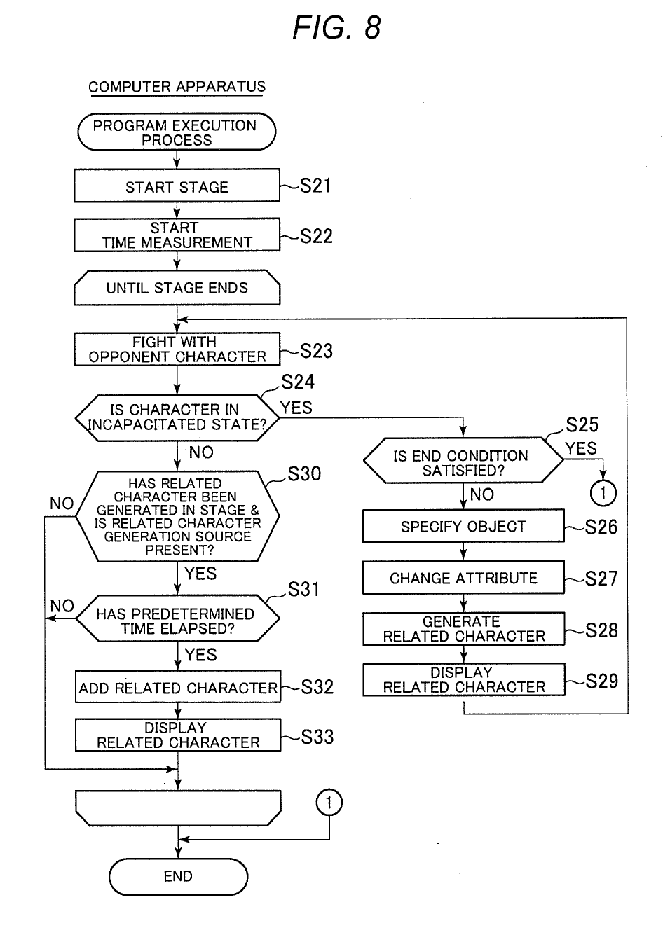

Next, a program execution process in the fourth embodiment of the invention will be described. FIG. 8 is a flowchart of a program execution process, which corresponds to at least one of the embodiments of the present invention.

The computer apparatus 1 causes the game starting unit 201 to perform a stage starting process including initial settings for a game field (Step S21). Next, the computer apparatus 1 causes the time measuring unit 202 to start time measurement by using the internal timer provided in the control unit 11 (Step S22).

Next, the computer apparatus 1 causes the fight processing unit 204 to perform fight processing between the player character and the opponent character (Step S23). The fight processing may be automatically progressed by the computer apparatus in a case where the player character encounters the opponent character and the player character may act to decrease the vitality value of the opponent character to a value equal to or lower than a predetermined value based on an operation performed by the player.

Next, the computer apparatus 1 causes the incapacitation determination unit 205 to determine whether the player character is in an incapacitated state (Step S24). The incapacitated state is a state of being not able to fight in the game and examples thereof include a state where the vitality value of the player character or a value indicating the mental power of the player character becomes equal to or lower than a predetermined value, a state of being not able to act by being paralyzed, and a state in which the number of destroyed body parts is equal to or greater than a predetermined number.

In a case where it is determined that the player character is in the incapacitated state (YES in Step S24), the end condition determination unit 203 determines whether an end condition is satisfied (Step S25). In a case where it is determined that the end condition is satisfied (YES in Step S25), the game becomes over and the process is terminated.

In a case where it is determined that the end condition is not satisfied (NO in Step S25), one or more object is specified from objects with which the player character is equipped (Step S26).

(Object Specification)

Specification of an object will be described. Regarding the specification of an object, the object specifying unit 206 specifies one or more objects from objects with which body parts of the player character are respectively equipped or objects owned by the player character. The specified object may be specified randomly or may be specified according to a predetermined rule.

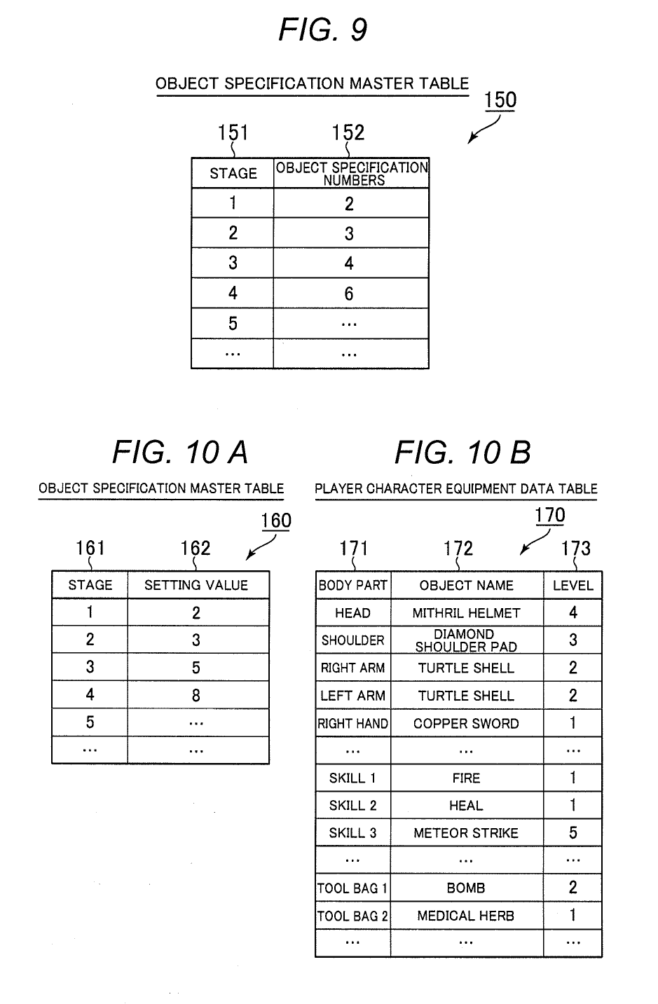

Here, as an example of the specification of an object, a case in which the number of objects to be specified is changed according to the progress of the game will be described. FIG. 9 is an example of an object specification master table, which corresponds to at least one of the embodiments of the present invention. Object specification numbers 152 are stored in an object specification master table 150 in relation to stages 151. In Step S24, the number of objects to be specified is determined based on the object specification number 152 according to the stage 151 corresponding to a stage in which the player character has entered the incapacitated state. Here, the stage 151 may be read as a difficulty related to a stage. That is, the game may be designed such that the number of objects to be specified is increased when the game is progressed and the player character is incapacitated at a late stage or a high-difficulty stage.

In addition, as a different mode related to the specification of an object, a case where a value indicating the worth of an object owned by the player character and a value set for each stage is compared with each other to specify an object will be described. FIG. 10A is an example of an object specification master table, which corresponds to at least one of the embodiments of the present invention. Setting values 162 are stored in an object specification master table 160 shown in FIG. 10A in relation to stages 161. Levels 173 are stored in a player character equipment data table 170 shown in FIG. 10B in relation to body parts 171 and object names 172.

In Step S24, the setting value 162 for determining the number of objects to be specified is determined according to the stage 161 corresponding to a stage in which the player character has entered the incapacitated state. For example, in a case where the player character enters the incapacitated state at a stage “3”, the setting value 162 is “5”. Here, the game may be designed as follows: the specification is performed such that the sum of values of the levels 173, which indicate the worth of objects, becomes equal to or lower than the setting value.

For example, in a case where the setting value is “5”, objects are specified such that the sum of values of the levels 173 of the objects becomes equal to or lower than “5”. Since the levels 173 related to the object names 172 “mithril helmet” and “copper sword” corresponding to the body parts 171 “head” and “right hand” are respectively “4” and “1” in the player character equipment data table 170, the sum of values of the levels becomes “5”, which is equal to or lower than the setting value “5”. Similarly, since the levels 173 related to the object names 172 “diamond shoulder pad” and “turtle shell” corresponding to the body parts 171 “shoulder” and “right arm” are respectively “3” and “2”, the sum of values of the levels becomes equal to or lower than the setting value “5”. Since it is sufficient that the setting value “5” is not exceeded, a case where the object name 172 is only “mithril helmet” and the level 173 is “4” may also be included. As described above, a combination of objects may be specified such that the setting value 162 determined according to the stage 161 is not exceeded.

Not only objects with which the player character is equipped are targets to be specified and for example, the game may be designed such that an object related to a “skill” and a “special ability” used by the player character or a region such as a tool bag in which an item can be managed is specified. For example, in case where the body part 171 is “skill 1” and the object name 172 “fire” is specified, a corresponding skill can be given to a related character which will be described later. In addition, when the object name 172 “bomb” is specified, a related character which will be described later has a “bomb” and can use the bomb in the game.

Referring again to the flowchart in FIG. 8, the computer apparatus 1 changes the attribute of the specified object (Step S27).

(Attribute Determination)

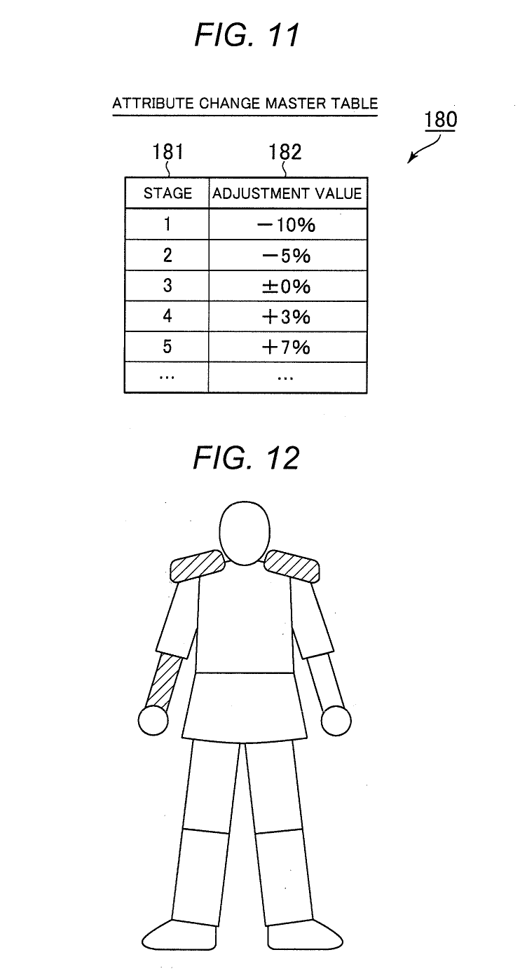

An object has an attribute and the attribute has an effect of changing a parameter of the player character when the player character is equipped with the object, an effect of improving the durability of the player character against an attack having a predetermined attribute, or the like. A change in attribute in Step S27 means causing the attribute changing unit 208 to change the attribute of the object specified in Step S26 according to the state of progress of the game or the difficulty. FIG. 11 is an example of an attribute change master table, which corresponds to at least one of the embodiments of the present invention. Adjustment values 182 are stored in an attribute change master table 180 in relation to stages 181. For example, in Step S24, the adjustment value 182 for adjusting the attribute of the object is determined according to the stage 181 corresponding to a stage in which the player character has entered the incapacitated state. For example, in a case where the stage 181 is “3”, the adjustment value 182 of the object is “±0%”. Therefore, there is no change in attribute of the object. Meanwhile, in a case where the stage 181 is “5”, the attribute of the object is changed by “+7%” and the changed attribute is related to a related character which will be described later. The stages 181 may be replaced with difficulties.

Referring again to the flowchart in FIG. 8, the computer apparatus 1 generates a related character related to the specified object based on data of the player character (Step S28). The specified object has the attribute changed in Step S27.

(Generation of Related Character)

A related character is generated based on the data of the player character determined as being in the incapacitated state in Step S24. The generated related character is equipped with the object specified in Step S26 and the attribute changed in Step S27 is applied thereto. In other words, the related character is related to the specified object of which the attribute is changed in consideration of an adjustment value corresponding to the state of progress of the game.

As the related character, a character of which the status is partially the same as that of the player character or a character that has the same object as the object specified in Step S26 is generated. The generated related character may be displayed with the display mode changed, for example. FIG. 12 is a diagram illustrating the display mode of the related character, which corresponds to at least one of the embodiments of the present invention. As for an example, as the human-type design of the related character, a design that is the same as that of the player character or a design that is different in color is used.

In a case where the related character is generated, the object display mode specifying unit 210 specifies the display mode of an object of the related character according to the display mode of a plurality of objects with which the player character is equipped. Then, the related character display mode specifying unit 211 specifies the display mode of the related character based on the display mode of the object specified in Step S26. Specifically, a shoulder and a right front arm portion, which are hatched in FIG. 12, are displayed to have the same color as objects with which the player character is equipped or to have a different color, and the object that is not specified may be displayed to have a semitransparent particle-like shape or may be displayed to have a mist-like shape such that the object cannot be clearly recognized.

When the related character is generated, the computer apparatus 1 causes the related character display unit 213 to display the related character (Step S29). A position at which the related character is displayed may be a random position or a fixed position in the game field. Then, the stage is restarted from a position at which it is determined that the player character is in the incapacitated state in Step S24 or from a predetermined position. As described above, in a case where it is determined that the player character is in the incapacitated state in Step S24, the player needs to replay the stage. In this case, the related character generated in Step S28 is controlled by the related character control unit 214 of the computer apparatus 1 and appears in the game as an opponent character of the player character.

In a case where the player character fights with the opponent character in Step S23 and it is determined that the player character is not in the incapacitated state (NO in Step S24), the computer apparatus 1 causes the related character generation source determination unit 212 to determine whether the related character has been generated in the stage and whether the generation source object that can generate the related character is present in the game field (Step S30). In a case where no related character has been generated or there is no generation source object (NO in Step S30), the process proceeds to a next fight.

The generation source object is, for example, an object that generates a related character. The generation source object may be a character or an inorganic object such as an old pot or a spacial door, for example. In addition, the generation source object may be the first character generated as a related character in the stage.

In a case where the related character has been generated in the stage and the generation source object of the related character is present in the game field (YES in Step S30), a time elapsed after a previous related character generation time point is determined (Step S31). In a case where it is determined that a predetermined time has elapsed (YES in Step S31), the related character generating unit 209 generates the related character again (Step S32). That is, in a case where the related character has been generated and the generation source object is present, the related character is generated again for each time the predetermined time elapses. The generated related character may be generated based on data related to the player character at a time point at which the player character is incapacitated in Step S24 and may be generated after the object specifying unit 206 specifies an object again. Alternatively, the related character may be generated based on data of the player character at a time point in Step S32.

Next, the computer apparatus 1 causes the related character display unit 213 to display the related character at a random position or a fixed position in the game field (Step S33).

The generated related character is controlled as an opponent character by the related character control unit 214. Therefore, in a case where the player character enters the incapacitated state even once, the number of related characters is continuously increasing as long as the generation source object is not defeated or destroyed. Accordingly, it becomes very difficult for the player to clear the stage. It is possible to stop the increase in the number of related characters by defeating or destroying the generation source object.

In a case where it is determined that the predetermined time has not elapsed in Step S31 (NO in Step S31), the process proceeds to a next fight. The processes from Step S23 to Step S33 are repeated until the stage ends. The end of the stage is determined by the end condition determination unit 203.

The related character may be generated only in a stage in which a condition in Step S24 is satisfied. In this case, no related character is generated in a stage in which the condition in Step S24 is not satisfied. Alternatively, the game may be designed such that the related character is generated again and again in a stage in which a player character is incapacitated even once in the past. For example, in the case of a game in which a combination of the same stages is repeated a plurality of times, the related character is generated based on information of the player character at a time point in the past at which the player character has been incapacitated, when the same stage is started for the second time or for the third time.

(Control of Related Character)

The related character is controlled as an opponent character by the related character control unit 214. Here, the related character control unit 214 may be designed to control the related character based on information related to the operation history of the player or based on information related to the action history of the player character. The expression “to control the related character based on history information” may mean to refer to the timing or frequency of actions such as attack, recovery, magic, skill, or evasion and to cause the related character to perform those actions at the approximately same rate.

In addition, control may be performed by using not only the operation history of the player or the action history of the player character but also a positional relationship between the player character and the opponent character. Examples of a case where the positional relationship is used include a case where an action of the player character is changed according to a distance to the opponent character. In a case where the player character is separated from the opponent character by a predetermined distance or more and has a fighting style in which a long-range attack is performed by using a long-range weapon (such as bow and arrow) or a skill, the related character is controlled such that the related character also performs a long-range attack frequently in a case where a distance between the characters is long.

In the above-described example, the stage is restarted from the first part thereof in a case where the player character enters the incapacitated state. However, the invention is not limited to this. For example, in the case of a game in which a fight is progressed by a team of a plurality of characters that can be operated by a player, the game may be continued even when one of members of the player's team is incapacitated. Even in a case where the team of the player character performs a fight, the example of the flowchart shown in FIG. 8 can be appropriately adopted as long as there is no conflict.

In addition, in a case where player characters act as a team, the above-described related character may be controlled based on history information related to a positional relationship between the player characters. For example, in a case where a fight is performed while the members of the team are divided into advance guards and rear guards, rear guard members fight using advance guard members. In addition, the advance guard members fight while protecting the rear guard members and expecting assists from the rear guard members. Therefore, the related character can be controlled based on the history information such that the team members perform cooperative play according to the roles thereof.

According to an aspect of the fourth embodiment, it is possible to provide a more interesting game. In particular, since the related character is generated based on data of the player character (first character) that satisfies a predetermined condition and the related character is controlled as the opponent character (second character), it is possible to make the player careful not to satisfy the predetermined condition and thus it is possible to provide a more interesting game.

According to an aspect of the fourth embodiment, the related character related to an object specified from objects owned by the first character is generated. Therefore, the related character is generated according to the state of the first character and thus it is possible to provide a more interesting game.

That is, if the player character with strong equipment satisfies a predetermined condition, the opponent character is caused to own strong equipment as with the player character, which may be disadvantageous for the player. On the contrary, if the player owns weak equipment, the equipment of the related character that appears becomes also weak. Therefore, satisfying the predetermined condition with weak equipment may be advantageous in progressing the game. Accordingly, it is possible to provide a more interesting game with improved strategy properties.

According to an aspect of the fourth embodiment, the second character that corresponds to the related character generated based on the data of the first character is controlled based on the history information that is related to an operation of the player with respect to the first character. Therefore, the second character can be controlled by using a pattern related to an operation that is consciously or unconsciously performed by a player (so-called player's habits in playing game) and thus it is possible to provide a more interesting game to the player. Furthermore, it is possible to provide information with which the player can be aware of his or her own pattern and play the game without being stuck in a pattern and thus it is possible to motivate the player to further focus on the game.

According to an aspect of the fourth embodiment, the generated related character is controlled in a stage in which the first character satisfies a predetermined condition. Therefore, it is possible to adjust the difficulty in units of stages and thus it becomes easier to adjust the game balance.

According to an aspect of the fourth embodiment, when an object as a related character generation source enters a state of being not able to fight with the player character, generation of the related character is stopped. Therefore, it is possible to provide a game requiring a higher strategy, which causes a player to progress the game while considering a time to defeat or destroy the object as a generation source.

According to an aspect of the fourth embodiment, in a case where the player character enters a state of being not able to fight, the related character is generated. Therefore, a cause-effect relationship, in which a player character incapacitated in a stage causes an opponent character generating a troublesome related character to appear in the stage, becomes clear to the player. Therefore, motivation for progressing the game cautiously and strategically so as to avoid incapacitation is provided and thus it is possible to provide a more interesting game.

According to an aspect of the fourth embodiment, at least one object is specified from the objects with which the body parts of the player character are respectively equipped. Therefore, it is possible to increase the number of the types of generated related characters and to provide a more interesting game.

According to an aspect of the fourth embodiment, the display mode of a specified object is changed so that the player can be visually recognize which object is effective. Therefore, it is possible to give a strategy to the game such that the player aims and attacks an ineffective object or the like and thus it is possible to provide a more interesting game.

According to an aspect of the fourth embodiment, the number of objects to be specified is changed according to the state of progress of the game or the difficulty. Therefore, it is possible to provide an appropriate opponent character according to the state of progress or the difficulty and thus it is possible to provide a more interesting game without making the user feel bored. In addition, it is possible to adjust the game balance only by changing the contents of data and it is possible to reduce an operational workload.

According to an aspect of the fourth embodiment, a degree to which the attribute of an object is changed is determined according to the state of progress of the game. Therefore, it is possible to provide an appropriate opponent character according to the state of progress without preparing a plurality of different types of objects and thus it is possible to provide a more interesting game without making the user feel bored.

According to an aspect of the fourth embodiment, the related character that is given an ability owned by the player character is generated. Therefore, it is possible to increase the variation between opponent characters and to provide a more interesting game.

According to an aspect of the fourth embodiment, the related character is controlled based on information related to an action of the player character. Therefore, an opponent character that performs actions similar to the operation pattern of the player is generated and the player needs to play the game in a style different from that in the past. Accordingly, it is possible to provide a more interesting game.

According to an aspect of the fourth embodiment, the opponent character is controlled based on information related to a distance between the player character and the opponent character, which is included in the information related to the operation history of the player or the action history of the player character. Therefore, it is possible to provide a more interesting game in which complicated control such as cooperative play or teamwork play is performed and which is improved in variation between actions of the opponent character.

With regard to the expressions “player”, “first character”, “second character”, “game”, “computer apparatus”, and “related character” in the fourth embodiment, the contents described in the first embodiment can be adopted within a necessary range. With regard to the expressions “object”, “to relate a character and an object”, and “to be owned”, the contents described in the second embodiment can be adopted within a necessary range.

In the fourth embodiment, the expression “stage” means one of units in which the game is partitioned and the game is progressed by clearing a plurality of consecutive stages. The expression “state of being not able to fight” means a state of being not able to fight in the game and examples thereof include a state where the vitality value of the player character or a value indicating the mental power of the player character becomes equal to or lower than a predetermined value, a state of being not able to act by being paralyzed, and a state in which the number of destroyed body parts is equal to or greater than a predetermined number.

In the fourth embodiment, the expression “degree to which the attribute is changed” means a rate at which the attribute is changed or a difference between the attribute before the change and the attribute after the change, for example. The expression “ability” means an action different from an action such as a normal attack and, which is set for each character, for example. The expression “information related to an action of the character” means the contents of an action performed according to a player's operation command and a command input such as an operation instruction, for example. The expression “information related to a distance” means information that indicates a distance between characters on a display screen or a positional relationship between characters, for example.

### Fifth Embodiment

Next, the outline of a fifth embodiment of the invention will be described. In the following description, as the fifth embodiment, a system for executing a fighting game in a server device, which can be connected to a computer apparatus provided with an input device such that the server apparatus can communicate with the computer apparatus, will be described with an example. As the game, for example, a game that is progressed by controlling a first character operated by a player and a second character fighting with the first character will be described.

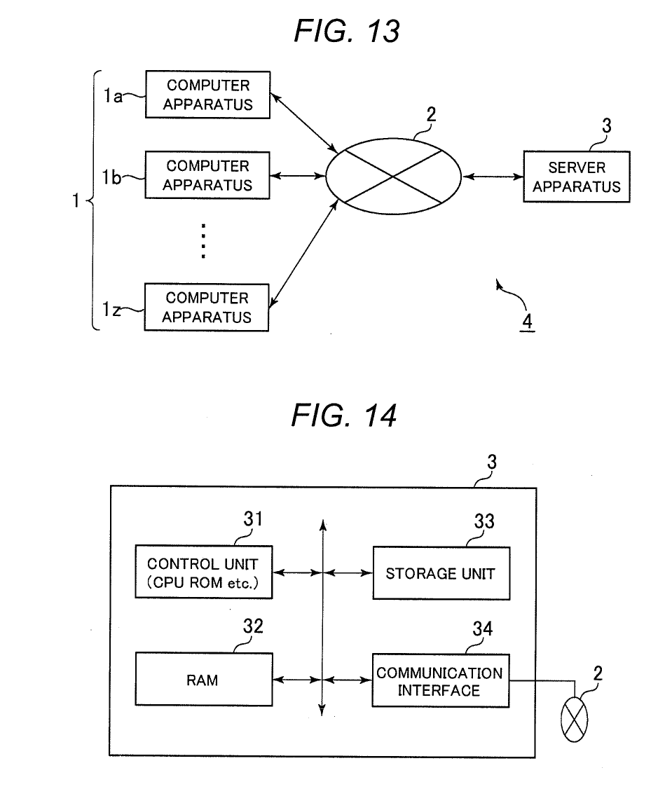

FIG. 13 is a block diagram illustrating a configuration of a system, which corresponds to at least one of the embodiments of the present invention. As illustrated in FIG. 13, a system 4 includes a plurality of computer apparatuses 1 (computer apparatuses 1a, 1b, . . . , 1z) operated by a plurality of users, a server apparatus 3, and the communication network 2. The computer apparatuses 1 are connected to the server apparatus 3 via the communication network 2. The computer apparatuses 1 may not be connected to the server apparatus 3 at all times as long as the computer apparatuses 1 can be connected as necessary.

With regard to the configuration of the computer apparatus according to the fifth embodiment, the same configuration as that illustrated in the block diagram of the computer apparatus in FIG. 6 can be adopted and the contents described in the description related to FIG. 6 can be adopted within a necessary range.

FIG. 14 is a block diagram illustrating a configuration of the server apparatus, which corresponds to at least one of the embodiments of the present invention. The server apparatus 3 includes a control unit 31, a RAM 32, a storage unit 33, and a communication interface 34, which are connected to each other via an internal bus.

A CPU or a ROM constitutes the control unit 31 and the control unit 31 executes a program stored in the storage unit 33 and controls the server apparatus 3. In addition, the control unit 31 includes an internal timer that measures time. The RAM 32 is the work area of the control unit 31. The storage unit 33 is a storage region for storing a program or data. The control unit 31 reads the program or data from the RAM 32 and executes a program execution process based on information received from the computer apparatus 1.

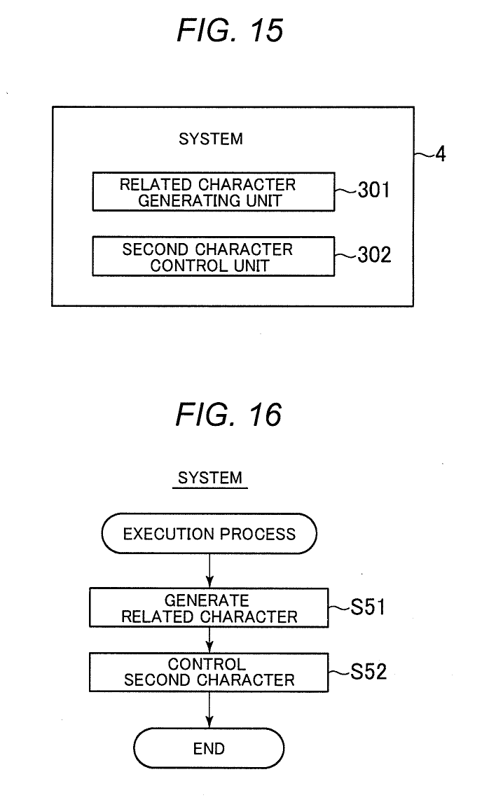

FIG. 15 is a block diagram illustrating a configuration of the system, which corresponds to at least one of the embodiments of the present invention. The system 4 includes at least a related character generating unit 301 and a second character control unit 302.

The related character generating unit 301 has a function of generating a related character related to the first character based on data of the first character. The second character control unit 302 has a function of controlling a related character generated by a related character generator as a second character in a case where the first character satisfies a predetermined condition.

Next, an execution process in the fifth embodiment of the invention will be described. FIG. 16 is a flowchart of an execution process, which corresponds to at least one of the embodiments of the present invention.

The system 4 generates a related character related to a first character based on the data of the first character (Step S51). Next, the system 4 controls a related character generated by a related character generator as a second character in a case where the first character satisfies a predetermined condition (Step S52) and terminates the process.

According to an aspect of the fifth embodiment, it is possible to provide a more interesting game.

In the fifth embodiment, with regard to the expressions “player”, “first character”, “second character”, “game”, “computer apparatus”, and “related character”, the contents described in the first embodiment can be adopted within a necessary range.

### APPENDIX

The description of the embodiments described above has been described so that those having ordinary knowledge in the field to which the invention belongs can carry out the following invention.

[1] A program which is executed in a computer apparatus providing a game that is progressed by controlling a first character operated by a player and a second character fighting with the first character, the program causing the computer apparatus to function as:

a related character generator that generates a related character related to the first character based on data of the first character; and

a second character controller that controls the related character generated by the related character generator as the second character in a case where the first character satisfies a predetermined condition.

[2] The program according to [1], further causing the computer apparatus to function as:

an owned object storage that stores the first character and an object owned by the first character such that the first character and the object are related to each other,

wherein the related character generator includes an object specifier that specifies at least one object from objects owned by the first character, and

wherein the related character generator generates the related character related to the specified object.

[3] The program according to [1] or [2], further causing the computer apparatus to function as:

a history storage that stores history information related to an operation of the player with respect to the first character,

wherein the second character controller controls the second character that corresponds to the related character generated based on the data of the first character, the second character being controlled based on the history information stored in the history storage.

[4] The program according to any one of [1] to [3],

wherein the game includes a plurality of stages, and

wherein the character controller controls the second character that corresponds to the related character generated based on the data of the first character in a stage in which the first character satisfies the predetermined condition.

[5] The program according to any one of [1] to [4],

wherein the related character generator repeatedly generates the related character, and

wherein the related character generator stops to generate the related character in a case where the second character becomes not able to fight in a fight between the first character and the second character controlled by the second character controller.

[6] The program according to any one of [1] to [5],

wherein the second character controller controls the second character that corresponds to the related character generated based on the data of the first character in a case where the first character becomes not able to fight.

[7] The program according to any one of [2] to [6],

wherein, for each object, which of a plurality of body parts of the first character is able to be equipped with the object is set, and

wherein the object specifier specifies at least one object from a plurality of objects with which the body parts of the first character are respectively equipped.

[8] The program according to [7],

wherein the related character generator includes
an object display mode specifier that specifies a display mode of a plurality of objects, with which body parts of the related character are respectively equipped, corresponding to a display mode of the plurality of objects, with which the body parts of the first character are respectively equipped, and
a related character display mode specifier that specifies a display mode of the related character based on a display mode of the specified object,

wherein the object display mode specifier specifies the display mode such that the object that is specified from the plurality of objects, with which the body parts of the first character are respectively equipped, by the object specifier and the object that is not specified are displayed in different display modes, and

wherein the program further causes the computer apparatus to function as:

a related character displayer that displays the related character on a display device according to the specified display mode of the related character.

[9] The program according to any one of [2] to [8],

wherein the number of objects to be specified by the object specifier is changed according to a state of progress of the game and/or difficulty of the game.

[10] The program according to any one of [2] to [9], further causing the computer apparatus to function as:

a change degree storage that stores a state of progress of the game and information indicating a degree to which an attribute of an object is changed such that the state of progress and the information are related to each other; and

an attribute changer that changes the attribute of the object to a degree corresponding to the state of progress of the game according to the state of progress.

[11] The program according to any one of [1] to [10],

wherein the related character generator generates the related character that is given an ability owned by the first character, and

wherein the second character controller controls the second character such that the second character uses the given ability.

[12] The program according to any one of [3] to [11],

wherein the history information stored in the history storage includes information related to an action of the first character, and

wherein the second character controller controls the second character that corresponds to the related character generated based on the data of the first character, the second character being controlled based on the information related to the action of the first character which is stored in the history storage.

[13] The program according to any one of [3] to [12],

wherein the history information stored in the history storage includes information related to a distance between the first character and the second character at the time of a fight between the first character and the second character, and

wherein the second character controller controls the second character that corresponds to the related character generated based on the data of the first character, the second character being controlled based on the information related to the distance.

[14] The program according to any one of [3] to [13],

wherein the history information stored in the history storage includes information related to a distance between the first character and another first character operated by another user at the time of a fight between the first character and the second character, and

wherein the second character controller controls the second character that corresponds to the related character generated based on the data of the first character, the second character being controlled based on the information related to the distance.

[15] The program according to any one of [1] to [14], further causing the computer apparatus to function as:

an attribute storage that stores an attribute of an object,

wherein the related character generator generates the related character that is related to the specified object and is given an attribute corresponding to the object.

[16] A computer apparatus providing a game that is progressed by controlling a first character operated by a player and a second character fighting with the first character, the apparatus comprising:

a related character generator that generates a related character based on data of the first character; and

a second character controller that controls the related character generated by the related character generator as the second character in a case where the first character satisfies a predetermined condition.

[17] A control method for a program which is executed in a computer apparatus providing a game that is progressed by controlling a first character operated by a player and a second character fighting with the first character, the method comprising:

generating a related character based on data of the first character; and

controlling the generated related character as the second character in a case where the first character satisfies a predetermined condition.

[18] A system which is realized in a terminal apparatus providing a game that is progressed by controlling a first character operated by a player and a second character fighting with the first character, and a server apparatus that is able to be connected to the terminal apparatus via communication, the system comprising:

a related character generator that generates a related character based on data of the first character; and

a second character controller that controls the related character generated by the related character generator as the second character in a case where the first character satisfies a predetermined condition.

1. A non-transitory computer-readable recording medium including a program which is executed in a computer apparatus providing a game that is progressed by controlling a first character operated by a player and a second character fighting with the first character, the program causing the computer apparatus to function as:
a related character generator that generates a related character related to the first character based on data of the first character; and
a second character controller that controls the related character generated by the related character generator as the second character in a case where the first character satisfies a predetermined condition.

2. The non-transitory computer-readable recording medium according to claim 1, further causing the computer apparatus to function as:
an owned object storage that stores the first character and an object owned by the first character such that the first character and the object are related to each other,
wherein the related character generator includes an object specifier that specifies at least one object from objects owned by the first character, and
wherein the related character generator generates the related character related to the specified object.

3. The non-transitory computer-readable recording medium according to claim 1, further causing the computer apparatus to function as:
a history storage that stores history information related to an operation of the player with respect to the first character,
wherein the second character controller controls the second character that corresponds to the related character generated based on the data of the first character, the second character being controlled based on the history information stored in the history storage.

4. The non-transitory computer-readable recording medium according to claim 1,
wherein the game includes a plurality of stages, and
wherein the character controller controls the second character that corresponds to the related character generated based on the data of the first character in a stage in which the first character satisfies the predetermined condition.

5. The non-transitory computer-readable recording medium according to claim 1,
wherein the related character generator repeatedly generates the related character, and
wherein the related character generator stops to generate the related character in a case where the second character becomes not able to fight in a fight between the first character and the second character controlled by the second character controller.

6. The non-transitory computer-readable recording medium according to claim 1,
wherein the second character controller controls the second character that corresponds to the related character generated based on the data of the first character in a case where the first character becomes not able to fight.

7. The non-transitory computer-readable recording medium according to claim 2,
wherein, for each object, which of a plurality of body parts of the first character is able to be equipped with the object is set, and
wherein the object specifier specifies at least one object from a plurality of objects with which the body parts of the first character are respectively equipped.

8. The non-transitory computer-readable recording medium according to claim 7,
wherein the related character generator includes
an object display mode specifier that specifies a display mode of a plurality of objects, with which body parts of the related character are respectively equipped, corresponding to a display mode of the plurality of objects, with which the body parts of the first character are respectively equipped, and
a related character display mode specifier that specifies a display mode of the related character based on a display mode of the specified object,
wherein the object display mode specifier specifies the display mode such that the object that is specified from the plurality of objects, with which the body parts of the first character are respectively equipped, by the object specifier and the object that is not specified are displayed in different display modes, and
wherein the program further causes the computer apparatus to function as:
a related character displayer that displays the related character on a display device according to the specified display mode of the related character.

9. The non-transitory computer-readable recording medium according to claim 2,
wherein the number of objects to be specified by the object specifier is changed according to a state of progress of the game and/or difficulty of the game.

10. The non-transitory computer-readable recording medium according to claim 2, further causing the computer apparatus to function as:
a change degree storage that stores a state of progress of the game and information indicating a degree to which an attribute of an object is changed such that the state of progress and the information are related to each other; and
an attribute changer that changes the attribute of the object to a degree corresponding to the state of progress of the game according to the state of progress.

11. The non-transitory computer-readable recording medium according to claim 1,
wherein the related character generator generates the related character that is given an ability owned by the first character, and
wherein the second character controller controls the second character such that the second character uses the given ability.

12. The non-transitory computer-readable recording medium according to claim 3,
wherein the history information stored in the history storage includes information related to an action of the first character, and
wherein the second character controller controls the second character that corresponds to the related character generated based on the data of the first character, the second character being controlled based on the information related to the action of the first character which is stored in the history storage.

13. The non-transitory computer-readable recording medium according to claim 3,
wherein the history information stored in the history storage includes information related to a distance between the first character and the second character at the time of a fight between the first character and the second character, and
wherein the second character controller controls the second character that corresponds to the related character generated based on the data of the first character, the second character being controlled based on the information related to the distance.

14. The non-transitory computer-readable recording medium according to claim 3,
wherein the history information stored in the history storage includes information related to a distance between the first character and another first character operated by another user at the time of a fight between the first character and the second character, and
wherein the second character controller controls the second character that corresponds to the related character generated based on the data of the first character, the second character being controlled based on the information related to the distance.

15. The non-transitory computer-readable recording medium according to claim 1, further causing the computer apparatus to function as:
an attribute storage that stores an attribute of an object,
wherein the related character generator generates the related character that is related to the specified object and is given an attribute corresponding to the object.

16. A computer apparatus providing a game that is progressed by controlling a first character operated by a player and a second character fighting with the first character, the apparatus comprising:
a related character generator that generates a related character based on data of the first character; and
a second character controller that controls the related character generated by the related character generator as the second character in a case where the first character satisfies a predetermined condition.

17. A control method for a program which is executed in a computer apparatus providing a game that is progressed by controlling a first character operated by a player and a second character fighting with the first character, the method comprising:
generating a related character based on data of the first character; and
controlling the generated related character as the second character in a case where the first character satisfies a predetermined condition.
